(19) United States
(12) Patent Application Publication
(10) Pub. No.: US 2003/0232236 A1
(43) Pub. Date: Dec. 18, 2003

(54) Battery package vent

(76) Inventors: Porter H. Mitchell, Carlsbad, CA (US); Wade W. Guindy, Henderson, NV (US)

Correspondence Address: VALENCE TECHNOLOGY, INC., 301 CONESTOGA WAY, HENDERSON, NV, 89015, US

(21) Appl. No.: 10/172,648

(22) Filed: Jun. 14, 2002

(51) Int. Cl. H01M 2/12

(52) U.S. Cl. 429/56; 429/2

(57) ABSTRACT

Battery packaging is described which permits gas generated inside of a battery package to safely escape through a vent. A sealant in communication with the vent substantially and selectively seals the vent. As the battery temperature rises to or above a minimum temperature, gas is generated. The heat causes the sealant to become substantially softened, such that the sealant unseals the vent, and the gas passes through the vent into the ambient atmosphere.

### FIELD OF THE INVENTION

This invention relates generally to a method and apparatus for venting or expelling gas generated or evolved within an electrochemical cell container, and more particularly to a method and apparatus employing heat-sensitive materials for venting or expelling pressurized gas generated or evolved within an electrochemical cell container.

### BACKGROUND OF THE INVENTION

Electrochemical cells or batteries typically consist of a cathode, an anode, and a liquid electrolyte or other material interposed there between for facilitating movement of ions between the anode and cathode. Batteries are commonly classified as either “primary” (non-rechargeable), or “secondary” (rechargeable).

Lithium-ion polymer batteries are a type of secondary battery. Most conventional lithium-ion polymer batteries use a relatively soft or flexible packaging or container, and employ a solid polymer electrolyte. As a result, lithium-ion polymer batteries are relatively thin (e.g., less than 10 mm thick), lightweight and easily shaped into different configurations and shapes.

A lithium-ion polymer battery typically includes one or more electrochemical cells, and employs the protective packaging or container portion to protect the electrochemical cell or cells from air and/or moisture infiltration. The packaging may be a flexible bag, pouch, or other similar package

Lithium-ion polymer cells evolve gas during storage as well as during and following service use. In some cases, a small volume of gas is typically evolved during normal use and storage, and at ambient temperatures. In many cases, an excessive volume of gas is generated or evolved, and therefore pressure is built-up, at elevated or abnormal temperatures. This gas may form for any number of reasons, e.g. breakdown of the electrolyte. When the battery packaging is sealed closed, excessive build-up of gas within the package must be vented or expelled to avoid any harm to the structural integrity and/or damage to the container, the electrochemical cells and/or the device in which the battery is employed.

Conventional venting systems typically employ pressure sensitive means for releasing gas evolved or generated within a container. However, such systems are inadequate because they require that excess amounts of pressure build before the vent system will release the gas, and thus may affect the structural integrity and/or may cause damage to the container over time. In contrast, the present invention employs temperature-sensitive means for releasing gas evolved or generated within a container, wherein the temperature sensitive means allows gas generated or evolved in the container to be vented or expelled, even if in small amounts. Thus, the present invention preemptively vents or expels gas before the gas builds to pressure levels sufficient to affect the structural integrity of the container.

Therefore, there exists a need for a method and apparatus for venting or expelling gas generated or evolved inside a battery package based on the operating temperature of the battery.

### SUMMARY OF THE INVENTION

In accordance with one embodiment of the present invention, a battery container for enclosing an electrochemical cell is provided, wherein gas is generated or evolved within the container when the operational temperature of the battery is at or above a given minimum temperature. The container includes a sealable vent and a sealant in communication therewith for selectively and substantially sealing the vent, wherein the sealant is a heat sensitive material that substantially seals the vent, but softens or melts when the electrochemical cell is operating at or above the minimum temperature, thus unsealing the vent so as to allow the gas to escape from the container through the vent.

### BRIEF DESCRIPTION OF THE DRAWINGS

The present invention will become more fully understood from the detailed description and the accompanying drawings, wherein:

FIG. 1 is a perspective view of a conventional battery, in accordance with the prior art;

FIG. 2 is a sectional view taken along line 2-2 of FIG. 1, in accordance with the prior art;

FIG. 3 is an exploded view of a battery system, in accordance with one embodiment of the present invention;

FIG. 4 is a perspective view of the assembled battery system depicted in FIG. 4, in accordance with one embodiment of the present invention;

FIG. 5 is a sectional view taken along line 5-5 of FIG. 4, in accordance with one embodiment of the present invention;

FIG. 6 is a perspective view illustrating an alternative battery system, in accordance with one embodiment of the present invention;

FIG. 7 is a sectional view illustrating the battery system under normal temperature and pressure conditions, in accordance with one embodiment of the present invention;

FIG. 8 is a sectional view illustrating the battery system under elevated temperature and pressure conditions, in accordance with one embodiment of the present invention;

FIG. 9 is a sectional view illustrating the battery system under elevated temperature and pressure conditions, in accordance with one embodiment of the present invention;

FIG. 10 is an exploded view of an alternative battery system, in accordance with an alternative embodiment of the present invention;

FIG. 11 is a perspective view of the assembled battery system depicted in FIG. 10, in accordance with an alternative embodiment of the present invention;

FIG. 12 is a sectional view taken along line 12-12 of FIG. 11, in accordance with an alternative embodiment of the present invention;

FIG. 13 is a sectional view illustrating the battery system under normal temperature and pressure conditions, in accordance with an alternative embodiment of the present invention;

FIG. 14 is a sectional view illustrating the battery system under elevated temperature and pressure conditions, in accordance with an alternative embodiment of the present invention; and

FIG. 15 is a sectional view illustrating the battery system under elevated temperature and pressure conditions, in accordance with an alternative embodiment of the present invention.

The same reference numerals refer to the same parts throughout the various Figures.

### DETAILED DESCRIPTION OF THE INVENTION

The following description of the preferred embodiments concerning the present invention is merely exemplary in nature, and is not intended to limit the invention or its application or uses. Furthermore, the present invention is not limited to any particular temperature or pressure range, and is intended to be practiced under any number of different temperature and pressure ranges. Moreover, while the present invention is described in detail below with reference to lithium-ion polymer batteries, it will be appreciated by those skilled in the art that the present invention is clearly not limited to only those specific types of batteries, but may be used with other batteries where internal gas pressures build to elevated levels.

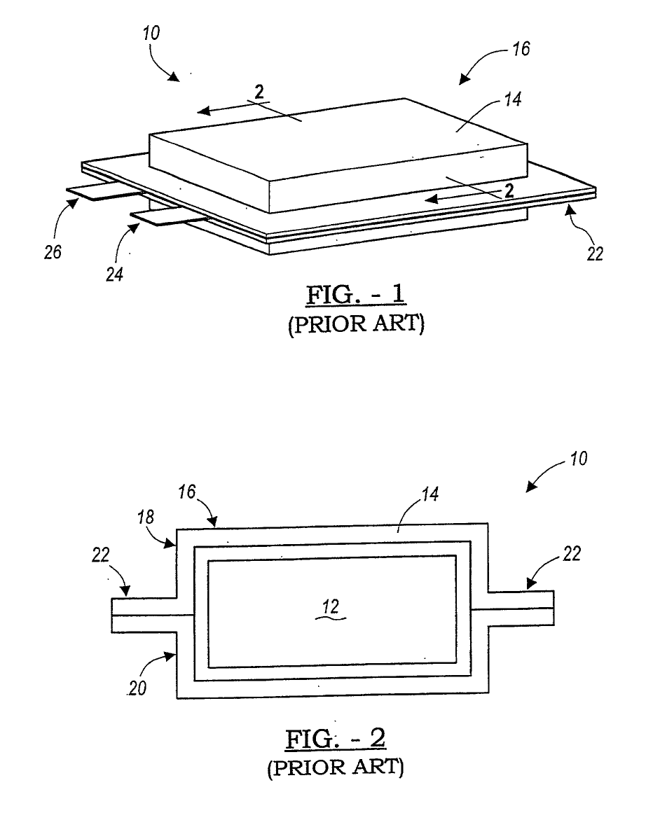

Referring to FIGS. 1 through 2, a conventional lithium-ion polymer battery 10 is shown having a rectangular prismatic shape (e.g., substantially box-shaped). The battery 10 includes an electrochemical cell 12 which is also of a rectangular prismatic shape. The electrochemical cell 12 is encapsulated in a flexible packaging material 14 (e.g., an aluminum foil pouch) having essentially the same shape as the electrochemical cell 12. Pouch 16 may be formed from two separate and substantially complementary sections 18 and 20 that are intended to be brought together to encapsulate electrochemical cell 12. Alternatively, pouch 16 may be formed from a unitary blank member (not shown) that is folded along one edge, with the two portions then being brought together to encapsulate electrochemical cell 12. As previously noted, one or more edges of pouch 16 are then brought together and generally heat sealed to form a flange-like structure 22 extending along the periphery of the battery structure. Pouch 16 is sealed around electrode tabs 24 and 26 while permitting tabs 24 and 26 to extend from pouch 16, thereby permitting the battery 10 to be in electrical communication with an external load (not shown).

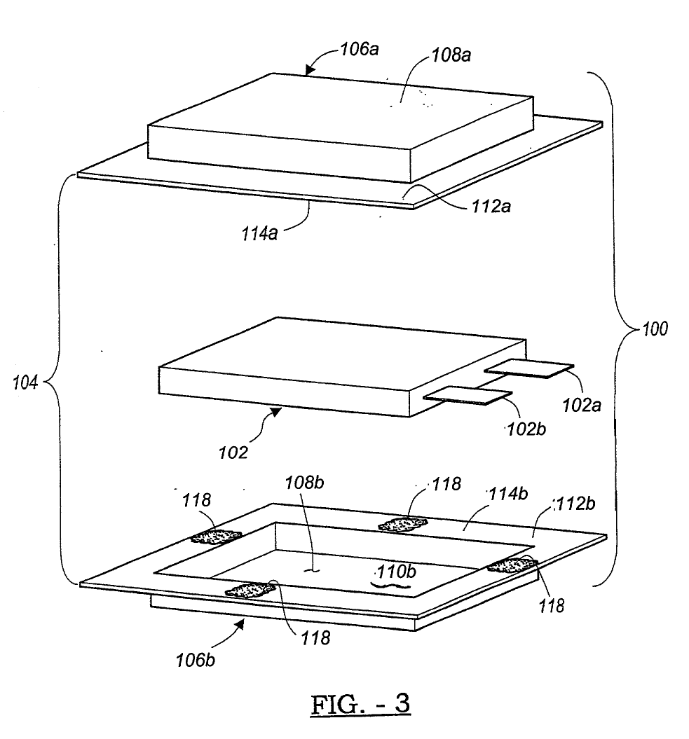

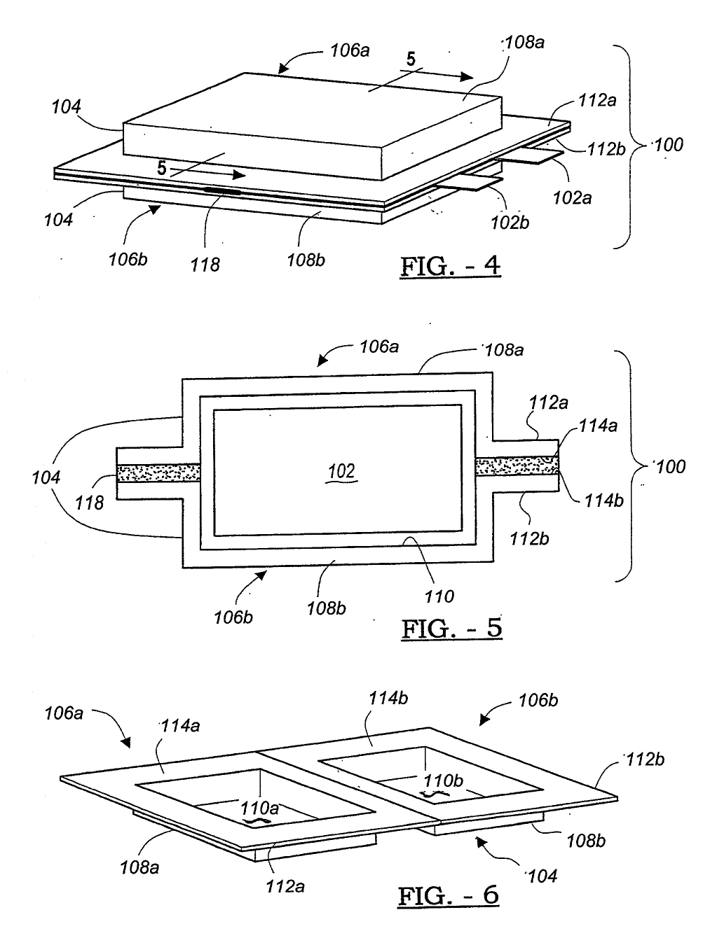

Referring to FIGS. 3 through 6, a battery system 100 in accordance with one embodiment of the present invention is shown. System 100 includes an electrochemical cell 102 and a container system 104 which encapsulates or envelopes electrochemical cell 102. A pair of electrode tabs 102a and 102b, respectively, corresponding to the anode and cathode (not shown), are in electrical communication with electrochemical cell 102, and extend outwardly away from electrochemical cell 102. Container system 104 generally at least encapsulates a portion of each electrode tab 102a, 102b, while permitting each electrode tab 102a, 102b to be in electrical communication with an external load (not shown).

As will be further discussed herein below, the container system 104 includes a vent for expelling gas generated or evolved within the container system 104. The vent can be in the form of an aperture through a wall of the container system 104 and/or could be formed at the intersection of two or more walls or surfaces of the container system 104. A temperature sensitive sealant in communication with the vent substantially seals the vent, and unseals the vent to allow for venting of gas evolved within the container system 104 when the operational temperature of the battery system 100 reaches a temperature that corresponds to a minimum temperature at which gas is generated or evolved within the container system 104. Preferably, the minimum temperature corresponds to a temperature at which “excessive” volumes of gas evolve within the container system 104. As used herein, the phrase “excessive volume of gas” means any volume of gas which, if left unvented, would affect the performance of the battery and/or would affect the structural integrity or result in a failure of the container system 104. Furthermore, the term “operational temperature” means the temperature of the battery system 104, which may result from either thermal energy emitted by the battery system 104 and/or thermal energy absorbed by the battery system 104 from its surroundings.

In one preferred embodiment, container system 104 includes two complementary container members 106a and 106b. The container members 106a, 106b are complementary and are substantially identically configured. Each container member 106a,106b includes a body 108a and 108b, respectfully, having a substantially rectangular-shaped recess 110a,110b for receiving electrochemical cell 102 (see FIGS. 3 and 6). Flange-like members 112a,112b extend along the periphery of each container member 106a and 106b, respectively.

Alternatively, container system 104 can be constructed of a single blank, as shown in FIG. 6, which is then folded along one or more edges to form a suitable container system. In either case, the container system 104 may be formed from a number of different materials suitable for containing the electrochemical cell 102 including, by way of a non-limiting example, metallic materials such as aluminum foil or the like.

Using conventional methods, system 100 can be assembled by bringing the container members 106a,106b together to encapsulate the electrochemical cell 102 such that the respective surfaces 114a and 114b of flange-like members 112a and 112b, respectively, are in adjacent and abutting co-planar communication. Heat is then applied to members 106a,106b, thus creating a heat seal at the interface of surfaces 114a and 114b. This creates an essentially air-tight and water-tight seal along the entire periphery of surfaces 114a,114b.

The sealant is preferably a sealant material 118, which is preferably disposed on one or both of flange-like surfaces 114 and 114a such that when system 100 is fully assembled, the flange-like member surfaces 114a,114b form a vent therebetween, and the sealant material 118 substantially and selectively seals the vent. In this embodiment, the sealant material 118 is preferably disposed between the flange-like surfaces 114a,114b. Although the sealant material 118 is shown as being applied only in discrete areas on the flange-like surfaces 114a,114b, it should be noted that sealant material 118 can also be applied as a continuous layer along one or both flange-like surfaces 114a,114b. Sealant material 118 can be applied in any number of ways, such as rolling, spraying, dipping, painting, inking, and the like. Once sealant material 118 is applied, the flange-like surfaces 114a,114b are brought together such that the container members 106a,106b encapsulate the electrochemical cell 102. Sealant material 118 adheres to surfaces 114 and 114a, thus creating an essentially air-tight and moisture-tight seal, and fixedly attaches the container members 106a, 106b to one another.

The sealant material 118 also provides a means for permitting gas pressure to escape from the interior of the packaging system 104. As previously noted, excessive levels of heat generated inside the packaging system 104 typically coincides with the production of gas, which builds up inside the packaging system 104 because there is no means of venting or expelling the gas. Once the pressure builds up to a certain point, there is generally a decrease in the structural integrity and/or a failure of the packaging system 104, which may damage or destroy the battery 100, and typically damages the electronic device housing the battery 100. The present invention overcomes this problem by employing a sealant material 118 that is a substantially “heat-sensitive” material. By “heat-sensitive” as that term is used herein, it is meant that the sealant material 118 is a substantially hard solid material below a preferably pre-determined temperature or temperature range, and is a substantially soft semi-solid or liquid material above a preferably pre-determined temperature or temperature range.

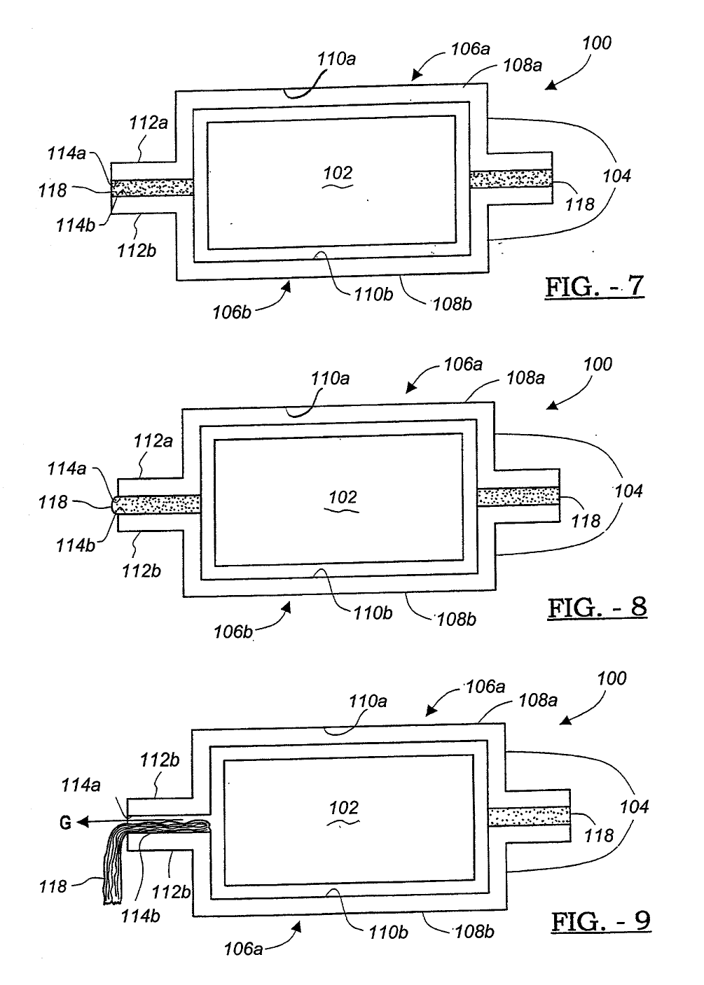

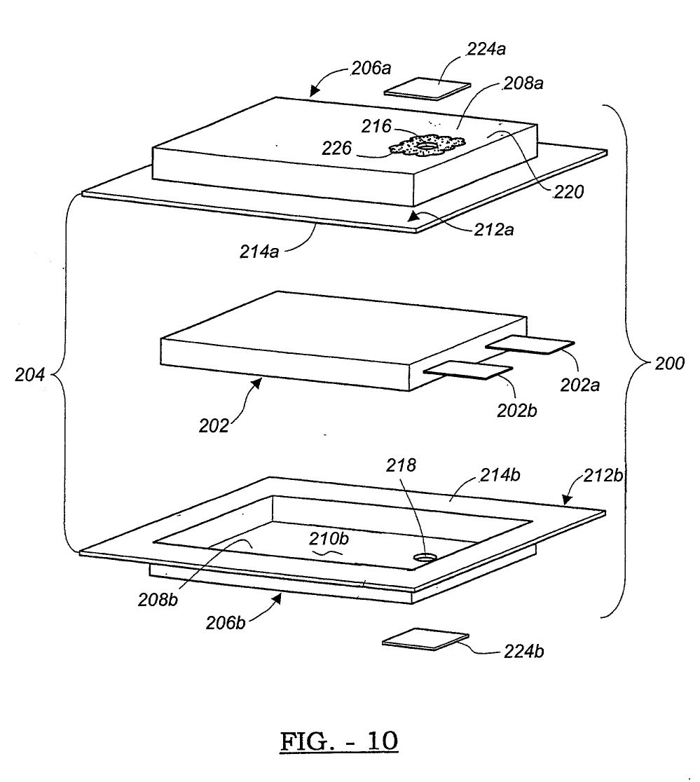

FIGS. 7 through 9 illustrate the operation of the present invention. FIG. 7 illustrates the present invention wherein the sealant material 118 is subjected to a temperature at which the sealant material 118 is a substantially hard, solid material. FIG. 8 illustrates the present invention as the operating temperature of the battery system 100 begins to elevate above the softening or melting point of the sealant material 118, and the sealant material 118 starts to become semi-solid or possibly liquid. The gas pressure begins to push or displace the semi-solid or possibly liquid sealant material 118 outwardly towards the ambient atmosphere, and/or may push or displace the semi-solid or possibly liquid sealant material 118 upwardly and/or downwardly against one or both of the flange-like surfaces 114a,114b. Once the semi-solid or possibly liquid sealant material 118, or a portion thereof, is displaced, the gas pressure G inside packaging system 104 passes to the ambient atmosphere (i.e., between surfaces 114a and 114b), thus permitting the venting of the gas pressure. It should be noted that the gas pressure can be vented simultaneously at other locations along the peripheral seal as well, and not just at the particular location depicted in FIG. 9.

The material that comprises sealant material 118 is preferably substantially non-reactive with respect to the materials employed to manufacture the packaging system 104 and the electrochemical cell 102, or any other structures of the battery system 100 not specifically discussed. The reason for this is that if sealant material 118 reacts with any of the afore-mentioned objects or materials, it could adversely affect the performance of battery system 100 or the performance of sealant material 118, as described above.

As noted above, the sealant material 118 employed is preferably substantially heat-sensitive, capable of fixedly attaching the container members 106a,106b together to encapsulate the electrochemical cell 102, and is non-reactive. As discussed above, another consideration in choosing a suitable sealant material 118 that is solid at or below a certain temperature or temperature range, and is semi-solid or liquid at or above another temperature or temperature range. Choosing an adhesive material that softens at too low a temperature range can potentially result in the premature softening or melting of the seal, i.e., when the internal gas pressure is relatively low and non-threatening. Conversely, choosing an adhesive material that softens at too high of an elevated temperature could potentially cause the seal around the packaging system (or any other portion of the battery system 100) to catastrophically fail, i.e., when the internal gas pressure is elevated above a desired pressure.

It should also be recognized that the battery operating temperature and gas pressure do not necessarily have a linear relationship with respect to the operating parameters of an electrochemical cell. For example, some electrochemical cells normally operate at relatively elevated internal temperatures, without any significant concurrent production of excessive amounts of gas. Conversely, some electrochemical cells normally operate at relatively low internal temperatures, which and produce excessive amounts of gas at a relatively lower temperature. Therefore, the sealant material 118 is preferably chosen to be a material that has a softening point temperature corresponding to the minimum temperature at which an “excessive” volume of gas is produced or generated within the particular container system 104. By way of a non-limiting example, with respect to lithium-ion polymer batteries, internal gas pressures in the range of about 15 to about 28 or more pounds per square inch (psi) are preferably avoided, and thus, choosing sealant material 118 having a softening point temperature corresponding to the temperature(s) at which gas is formed in amounts corresponding to this particular pressure range would be preferred in order to relieve the gas pressure. In accordance with a preferred embodiment, it is preferred to employ a sealant material 118 that has a softening point temperature corresponding to the temperature(s) at which an a sufficient amount of gas is formed to produce an internal gas pressure in the range of about 22 to about 28 or more psi. Although the temperature at which the generation of sufficiently elevated enough gas pressures will occur will vary, as previously noted, it is preferred to employ a sealant material 118 that has a softening point in the range of about 100 to about 200 degrees Celsius.

Preferably, the sealant material 118 is one or more thermoplastic or thermoset polymeric materials, preferably one or more thermoplastic adhesive materials. Preferred thermoplastic materials include, but are not limited to, polyolefins. Preferred polyolefins include, but are not limited to polyethylene. A preferred polyethylene is low molecular weight polyethylene, also commonly referred to as polyethylene wax.

Another preferred adhesive material is selected from the group of adhesives commonly referred to as “hot-melt” adhesives. Hot-melt adhesives are 100% solids that, in the broadest sense, include all thermoplastics. Materials that are primarily used as hot-melt adhesives include ethylene/vinyl acetate copolymers (EVA), polyvinyl acetates (PVA), as previously mentioned, polyethylene (PE), amorphous polypropylene, block copolymers such as those based on styrene and elastomeric segments or ether and amide segments (i.e., thermoplastic elastomers), polyamides, and polyesters. Other adhesive materials having the same or similar chemical and/or physical properties and characteristics of hot-melt adhesives are also envisioned to be suitable to practice the present invention.

In general, hot-melt adhesives are solid at temperatures below 79° C. (175° F.). Ideally, as the temperature is increased beyond this point, the material rapidly softens or melts to a low-viscosity fluid that is flowable and mobile. Upon cooling, the adhesive sets rapidly (i.e., hardens). Because these materials are thermoplastic, the melting/softening-resolidification process is repeatable with the addition and removal of the required amount of heat.

To select a suitable adhesive material, the minimum temperature or temperature range within which unacceptable or undesirable gas pressure levels form inside the packaging system is first determined. Next, a sealant material 118 is chosen which softens or melts at a temperature or within a temperature range substantially corresponding to (or even below) the temperature range during which “excessive” volumes of gas evolve inside the packaging system 104. In this manner, each time gas pressure builds to sufficiently elevated enough levels, the sealant material 118 will soften, thus allowing the gas pressure to safely and automatically vent to the ambient atmosphere. Thereafter, when the temperature of the battery system 100 drops to below the softening point temperature of the sealant material 118, the sealant material 118 hardens, thus substantially reforming the original seal.

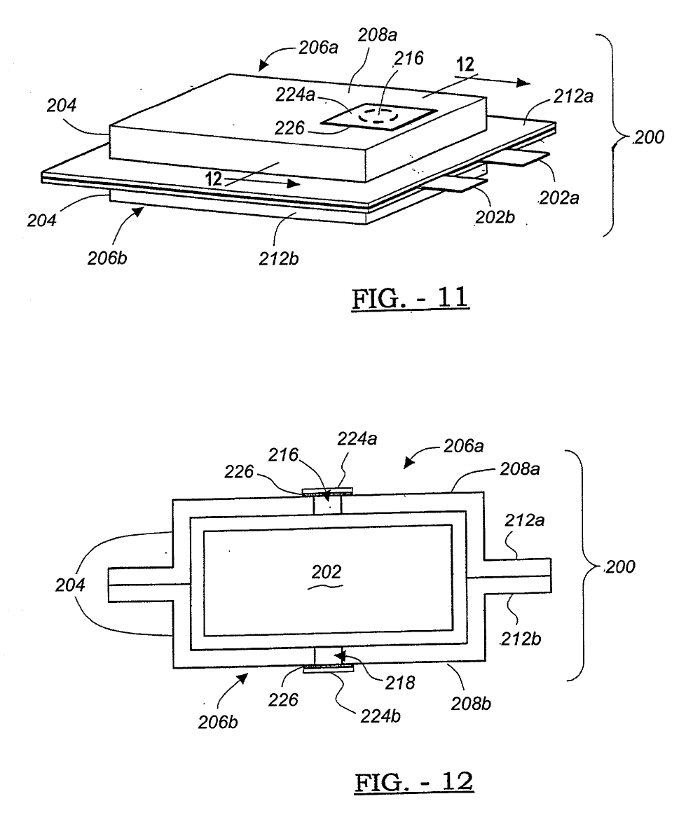

Referring to FIGS. 10 through 12, an alternative battery system 200 is shown, in accordance with an alternative embodiment of the present invention. As with the previously described embodiment, system 200 primarily includes an electrochemical cell 202 and a container system 204 which is intended to encapsulate or envelope electrochemical cell 202. A pair of electrode tabs 202a and 202b, respectively, corresponding to the anode and cathode, are in electrical communication with electrochemical cell 202, and extend outwardly away from electrochemical cell 202. Container system 204 generally at least encapsulates a portion of the electrode tabs 202a,202b, respectively, while permitting the electrode tabs 202a,202b to be in electrical communication with an external load (not shown).

Again, container system 204 includes two complementary container members 206a and 206b. Each container member 206a,206b includes a body 208 having a substantially rectangular-shaped recess defined by surface 210a,210b for receiving electrochemical cell 202 (see FIGS. 10 and 12). Each container member 206a,206b includes a flange-like member 212a and 212b, respectively, extending along the periphery thereof. Alternatively, container system 204 can be constructed of a single blank which is then folded along one or more edges to form a suitable container system, as previously shown in FIG. 6.

As shown in FIG. 10, apertures or vents 216 and 218, respectively, extend through substantially planar surface 220 and 222, respectively, of container bodies 208a and 208b, respectfully. Preferably, vents 216 and 218 are substantially aligned with one another. While the vents 216,218 are shown in the Figures as being circular in shape, other geometrical shapes may be employed, and shape of the vents 216,218 is not thought to be critical to the invention.

Each vent 216,218 is covered by a non-reactive vent cover 224a and 224b, respectively. The vent covers 224a,224b can be manufactured from any number of suitable materials, such as metals (e.g., metallized MYLAR™, aluminum foil, and so forth), thermosets, thermoplastics, and the like. It is most preferred that the vent covers 224a,224b employed be inert with respect to the components of electrochemical cell 202 or packaging system 204.

In order to secure vent covers 224a,224b over vents 216 and 218, respectively, it is necessary to employ a sealant material 226. Again, it is preferred to employ the substantially non-reactive and heat-sensitive adhesive materials previously discussed in relation to the first embodiment, i.e., polymeric materials such as thermoplastic and thermoset materials, and especially those materials characterized as hot-melt adhesives.

By way of a non-limiting example, sealant material 226 is applied around the periphery of each vent 216,218 in accordance with any number of suitable methods, such as, but not limited to, rolling, spraying, dipping, painting, inking, and the like. Once sealant material 226 has been applied, each vent cover 224a,224b is then placed on top of sealant material 226, thus covering their respective vents 216 and 218, respectively, and establishing a substantially air-tight and moisture-tight seal about each vent 216 and 218, respectively. Alternatively, cover material 224 can be pre-fabricated to include a sealant material thereon or embedded therein, if so desired. The purpose of vents 216,218 is to allow the venting of elevated pressure gas there through, instead of or in addition to allowing the elevated pressure gas to vent through the peripheral seal, as previously described in the first embodiment.

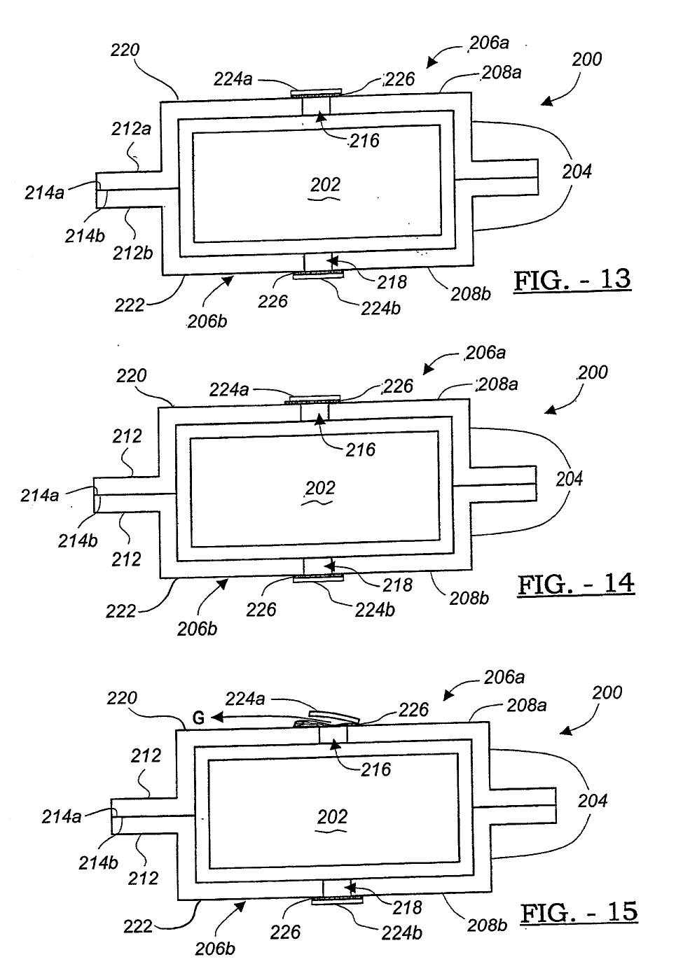

FIGS. 13 through 15 illustrate the operation of the alternate embodiment of the present invention. FIG. 13 illustrates the present invention wherein the sealant material 216 is subjected to a temperature at which the sealant material 216 is a substantially hard, solid material. FIG. 14 illustrates the present invention as the temperature begins to elevate above the softening or melting point of the sealant material 216, and the sealant material 216 starts to become semi-solid or possibly liquid. The gas pressure begins to push or displace the semi-solid or possibly liquid sealant material 216 outwardly towards the ambient atmosphere, and/or may push or displace the semi-solid or possibly liquid sealant material 216 upwardly against the respective vent cover 224a,224b, and/or downwardly against the respective container body planar surface 220,222. Once the semi-solid or possibly liquid sealant material 216, or a portion thereof, is displaced, the gas pressure G inside packaging system 204 passes to the ambient atmosphere, thus permitting the venting of the gas pressure. It should be noted that the gas pressure can be vented simultaneously at vent 218 as well, and not just at vent 216 as depicted in FIG. 15.

It is further envisioned that the present invention can be practiced by simultaneously employing both a peripheral seal, as described in relation to the first embodiment, as well one or more vents or apertures, as described in relation to the alternative embodiment. In this regard, a battery system could have a sealant material disposed in between the peripheral seal, as well as a pair of vent holes which are covered with cover members releasably held in place with a sealant material.

The foregoing description is considered illustrative only of the principles of the invention. Furthermore, because numerous modifications and changes will readily occur to those skilled in the art, it is not desired to limit the invention to the exact construction and process shown as described above. Accordingly, all suitable modifications and equivalents that may be resorted to that falls within the scope of the invention as defined by the claims that follow.

What is claimed is:

1. A container for enclosing an electrochemical cell, wherein gas evolves within the container when the electrochemical cell operates at or above a minimum temperature, comprising:
a vent through which the gas is selectively released; and
a sealant in communication with the vent for selectively sealing the vent, wherein the sealant has a softening point temperature approximately equal to the minimum temperature at which gas evolves;
whereby when an electrochemical cell is encapsulated within the container and the operating temperature of the electrochemical cell elevates from below the minimum temperature to above the minimum temperature, gas evolves within the container, the sealant softens and unseals the vent, and the gas is released through the vent.

2. The invention according to claim 1, wherein the vent is formed along at least a portion of an intersection of two surfaces of the container.

3. The invention according to claim 2, wherein the first and second surfaces are substantially co-planar.

4. The invention according to claim 3, wherein the sealant is disposed within the intersection.

5. The invention according to claim 4, wherein the sealant is an thermoplastic material having adhesive properties for fixedly attaching the two surfaces together when the electrochemical cell is operating at a temperature below or approximately equal to the minimum temperature.

6. The invention according to claim 1, wherein the vent is an aperture extending through a wall of the container.

7. The invention according to claim 6, further comprising a cover for covering the aperture, wherein the sealant is disposed between the cover and the periphery of the aperture.

8. The invention according to claim 7, wherein the sealant is an thermoplastic material having adhesive properties for fixedly attaching the cover to the container when the electrochemical cell is operating at a temperature below or approximately equal to the minimum temperature.

9. A battery, comprising:
an electrochemical cell;
a container for encapsulating the electrochemical cell, the container having a vent for selectively releasing gas evolved within the container; and
a sealant in communication with the vent for selectively sealing the vent, wherein the sealant has a softening point temperature approximately equal to the minimum temperature at which an excessive volume of gas evolves within the container;
whereby when the electrochemical cell is encapsulated within the container and the operating temperature of the electrochemical cell elevates from below the minimum temperature to above the minimum temperature, gas evolves within the container, the sealant softens and unseals the vent, and the gas is released through the vent.

10. The invention according to claim 9, wherein the vent is formed along at least a portion of an intersection of two surfaces of the container.

11. The invention according to claim 10, wherein the first and second surfaces are substantially co-planar.

12. The invention according to claim 11, wherein the sealant is disposed within the interface.

13. The invention according to claim 12, wherein the sealant is an thermoplastic material having adhesive properties for fixedly attaching the two surfaces together when the electrochemical cell is operating at a temperature below or approximately equal to the minimum temperature.

14. The invention according to claim 9, wherein the vent is an aperture extending through a wall of the container.

15. The invention according to claim 14, further comprising a cover for covering the aperture, wherein the sealant is disposed between the cover and the periphery of the aperture.

16. The invention according to claim 15, wherein the sealant is an thermoplastic material having adhesive properties for fixedly attaching the cover to the container when the electrochemical cell is operating at a temperature below or approximately equal to the minimum temperature.

17. A method of releasing gas evolved within the container when the electrochemical cell operates at or above a minimum temperature gas created by an electrochemical cell at a minimum temperature in a container that is sealed using a sealant having a softening point temperature approximately equal to the minimum temperature, comprising:
softening the sealant; and
releasing the pressurized gas from the container.

18. A battery system, comprising:
an electrochemical cell capable of producing heat;
a container encapsulating the electrochemical cell, wherein the container includes a first aperture and a second aperture;
a first cover member for covering the first aperture;
a second cover member for covering the second aperture; and
a sealant material disposed between the first cover member and periphery of the first aperture and between the second cover member and the periphery of the second aperture;
wherein the heat is sufficient to permit the formation of a pressurized gas within the container;
wherein the sealant material is capable of becoming substantially softened when exposed to the heat so as to permit the pressurized gas to pass between either one of the first cover member and the first surface and the second cover member and the second surface into the ambient atmosphere.
